(19) United States
(12) Patent Application Publication
(10) Pub. No.: US 2010/0078914 A1
(43) Pub. Date: Apr. 1, 2010

(54) Storage and carrying rack

(76) Inventor: Stephen Pavlik, Sterling, MI (US)

Correspondence Address: MCKELLAR IP LAW, PLLC, 784 SOUTH POSEYVILLE ROAD, MIDLAND, MI, 48640, US

(21) Appl. No.: 12/387,855

(22) Filed: May 8, 2009

Related U.S. Application Data
(60) Provisional application No. 61/127,121, filed on May 9, 2008.

(51) Int. Cl. B60D 1/36

(52) U.S. Cl. 280/477

(57) ABSTRACT

A storage and carrying rack for a military hitching apparatus. This carrying rack allows for the quick hitching and unhitching of various trailers, cannon, and other military equipment that are towed on wheels.

This application is a utility application claiming priority from U.S. provisional patent application having Ser. No. 61/127,121, filed May 9, 2008.

### BACKGROUND OF THE INVENTION

This invention deals with a storage and carrying rack for a military hitching apparatus. Military vehicles are equipped with a universal hitching system that is called a pintle mount. This system allows for the quick hitching and unhitching of various trailers, cannon, and other military equipment that are towed on wheels. This arrangement is opposed to the conventional ball hitch that is common on civilian vehicles. The pintle mount consists of a hitch on the towing vehicle that is essentially a clamp apparatus wherein the lower portion is stabilized and the upper portion moves in an up and down motion to open and close the clamp. The other part of the pintle mount is the tow bar.

In today's modern army, it is a requirement that such a hitching mechanism must be carried with each vehicle. Typically, this hitching means is stored in the rear of the vehicle and it takes on the order of 10 to 15 minutes to drop the tailgate of the vehicle, open the storage bin, release the hitching mechanism, lay the hitching mechanism on the ground, then pick it up again, and attach it to the vehicle and the towed vehicle, and that is because the hitching mechanism is stored inside of the carrying vehicle and can only be reached when the tailgate of the carrying vehicle is dropped downwardly. The hitching mechanism has then to be laid aside until the storage cabinet is closed and the tailgate moved upwardly to its closed position. Usually, this means placing the hitching mechanism on the ground and then picking it up again when the storage bin and the tailgate have been closed.

The storage and carrying rack of this invention overcomes all of the problems associated with the current means of carrying and installing the hitching means.

The inventor herein is not aware of any prior art storage and carrying racks that will accomplish the same adjectives and provide the benefits of the device of the instant invention.

### THE INVENTION

What is therefore disclosed and claimed herein is a storage and carrying rack comprising a mounting plate having a near end, a distal end, a bottom edge, a front surface, a back surface and a top edge.

There is a hook mounted near the distal end and on the front surface of the mounting plate and at least one set of openings through the front surface and through the back surface of the mounting plate.

There is at least one upper bracket mounted perpendicularly to the front surface and near the top edge of the mounting plate, near the near end and at least two spaced-apart lower brackets mounted perpendicularly to the front surface and near the bottom edge of the mounting plate, at least one lower bracket is mounted near the near end of the mounting plate.

### BRIEF DESCRIPTION OF THE DRAWINGS

FIG. 1 is a full front view of a Humvee vehicle with the inventive device mounted on the front of the vehicle and a tow eye mounted on the device.

FIG. 2 is a full front view of the device of this invention.

FIG. 3 is an end view of the device of this invention.

FIG. 4 is a full top view of a tow eye that is mounted on the inventive device.

### DETAILED DESCRIPTION OF THE DRAWINGS

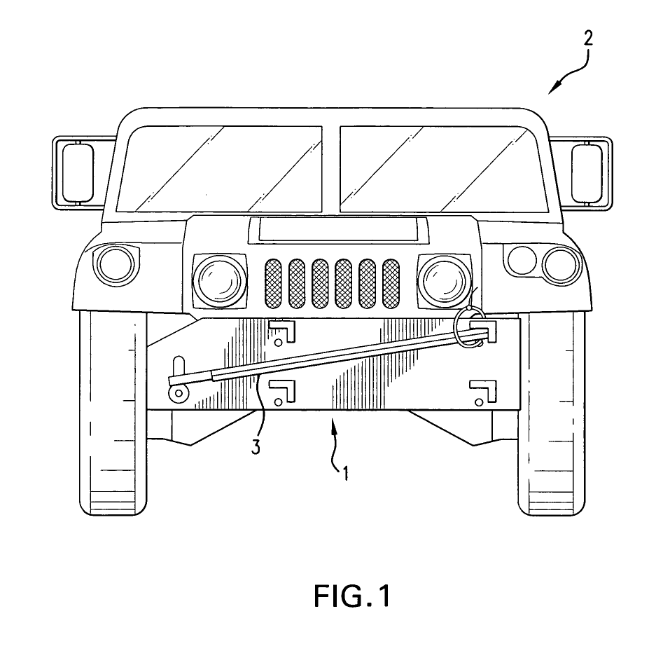

FIG. 1 is a full front view of a depiction of a Humvee vehicle 2 with the inventive device 1 mounted on the front 4 of the vehicle and a pintle tow bar 3 mounted on the device 1.

The hitching device shown in FIG. 4 is called a pintle tow bar 3 and is comprised of an eye 4 that drops down over a hitch mounted on the towing vehicle (not shown). The pintle tow bar 3 has two long tow bars attached to it, one is static 5 and the other is movable 6 around the perimeter of the eye 4 to enable the hitch to fit various sized vehicles. The ends 7 of the long tow bars distal to the eye 4 are fitted with a means 8 to attach to a towed trailer or the like.

In use, the pintle tow bar 3 eye 4 drops over the lower part of the clamp hitch and the top part of the hitch drops down to hold the pintle tow bar 3 on the hitch. The means 8 on the distal ends 7 are essentially yolks with aligned holes through the yolks in which is fitted a pin. The pin is then fitted with a cotter pin to hold the pin in place.

The clamp mechanism and the eye 4 of the pintle tow bar are designed such that when coupled together, they form a FIG. 8. This configuration allows for the maximum flexibility for the pintle tow bar 3 in rough terrain.

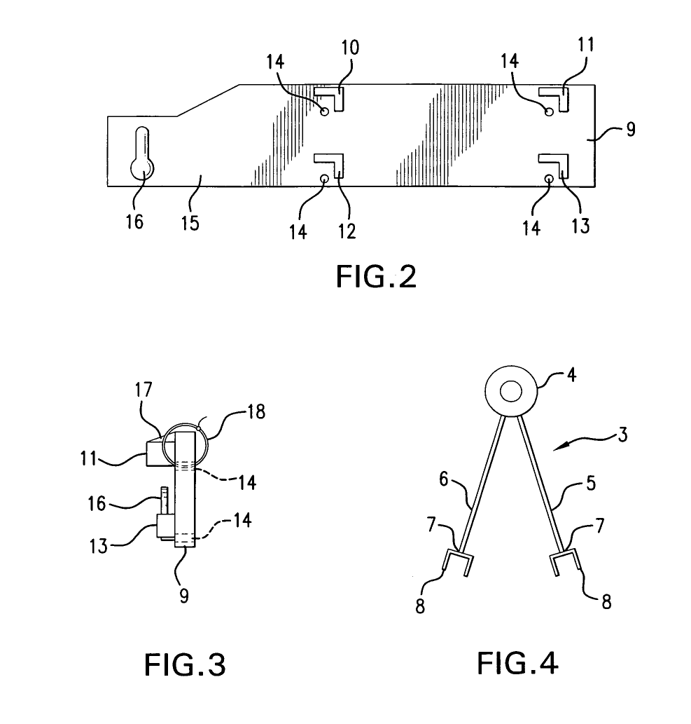

Turning now to the invention, the device 1 of this invention is comprised of a flat metal panel 9 (FIG. 2) that has spaced top bars 10 and 11, and spaced bottom bars 12 and 13 that are permanently attached vertically to the flat plane of the panel 9. Bottom bars 12 and 13 act as a shelf onto which the long tow bars 5 and 6 can rest until put into use or stored up against the top bar 11. As illustrated herein, the bars 10, 11, 12, and 13 are manufactured from angle iron, but this is not critical to the invention. What is needed is bar material that will endure the rigors of the use of the device.

The flat panel 9 has at least four openings 14 through it to allow the attachment of the flat panel to the front of the Humvee as shown in FIG. 1.

On the front surface 15, essentially on the end opposite of the spaced top and bottom bars is a hook 16 on which the eye 4 of the pintle tow bar 3 rests during storage. Optionally, there can be provided a support brace 17 as shown in FIG. 3. In addition, the device of this invention provides for a securing strap 18, also shown in FIG. 3.

The combination of the eye 4, the arms 5 and 6, and the attachment means 8 distal ends 7 weigh about two hundred pounds and thus traditionally has to be carried by the vehicle to which the towed vehicles have to be attached. The device of this invention provides a means of storing that is convenient and a means of holding the pintle tow bar for eventual use without having to place it on the ground to be lifted again.

The device 1 of this invention is preferably manufactured out of metal, most preferably steel or cast iron.

What is claimed is:

1. A storage and carrying rack comprising:
a. a mounting plate having a near end, a distal end, a bottom edge, a front surface, a back surface and a top edge;
b. a hook mounted near the distal end and on the front surface of the mounting plate;
c. at least one set of openings through the front surface and through the back surface of the mounting plate;
d. at least one upper bracket mounted perpendicularly to the front surface and near the top edge of the mounting plate, near the near end;
e. at least two spaced-apart lower brackets mounted perpendicularly to the front surface and near the bottom edge of the mounting plate, at least one lower bracket mounted near the near end of the mounting plate.
